(19) United States
(12) Patent Application Publication
(10) Pub. No.: US 2009/0194674 A1
(43) Pub. Date: Aug. 6, 2009

(54) CONTROLLER FOR A PHOTOSENSOR

(76) Inventor: Yuyun Shih, Fremont, CA (US)

Correspondence Address: APPLIED OPTOELECTRONICS, INC., 13115 JESS PIRTLE BLVD., SUGAR LAND, TX, 77478, US

(21) Appl. No.: 12/024,022

(22) Filed: Jan. 31, 2008

(51) Int. Cl. G01J 1/44; H04B 10/00

(52) U.S. Cl. 250/214 R; 398/135

(57) ABSTRACT

The subject matter disclosed herein relates to a method and/or system for driving a photosensor.

### FIELD

Subject matter disclosed herein relates to a circuit to drive a photosensor.

### BACKGROUND

Modern communication networks, comprising telecommunications and data communications, typically incorporate optical signals with electrical signals. For a variety of reasons, one therefore may convert optical signals to electrical signals, or vice versa throughout many stages of a communication network. For example, a termination of a fiber optic trunk line may involve a conversion of its optical signals into electrical signals that subsequently become routed into electrical-based equipment. Afterwards, the electrical signals may then be converted back to optical signals. Optical transceivers are generally used to convert between electrical and optical signals.

Industry consensus has resulted in optical transceiver modules that meet common electrical, management, and mechanical specifications. Such a module is commonly referred to as a small form-factor pluggable (SFP) module. One newer high-speed variant is commonly referred to as an XFP module.

As data rates grow beyond 10 Gb/sec, the receiver portion of transceiver systems are increasingly being transitioned from positive-intrinsic-negative (PiN) photodiodes to avalanche photodiodes (APD) for improved receiver sensitivity. But using an APD may involve careful finesse of its operating conditions, including drive bias voltage level and temperature level, for example. To make matters more difficult, it may be desirable to drive an APD within such conditions in a space-limited module, such as an XFP or SFP module.

### BRIEF DESCRIPTION OF THE FIGURES

Non-limiting and non-exhaustive embodiments will be described with reference to the following figures, wherein like reference numerals refer to like parts throughout the various figures unless otherwise specified.

FIG. 1 is a circuit diagram showing a configuration of a photosensor circuit.

FIG. 2 is a graph of avalanche photodiode (APD) gain versus bias voltage for a particular embodiment.

FIG. 3 is a graph of APD dark current versus reverse voltage for a particular embodiment.

FIG. 4 is a perspective diagram of an embodiment of an XFP module.

FIG. 5 is a schematic diagram of another embodiment of an XFP module.

FIG. 6 is a circuit diagram showing an embodiment of a photosensor controller.

FIG. 7 is a circuit diagram showing an embodiment of a filter.

FIG. 8 is a circuit diagram showing an embodiment of a photosensor controller.

FIG. 9 is a circuit diagram showing an embodiment of a photosensor controller.

### DETAILED DESCRIPTION

Reference throughout this specification to “one embodiment” or “an embodiment” means that a particular feature, structure, or characteristic described in connection with an embodiment is included in at least one embodiment of claimed subject matter. Thus, appearances of the phrase “in one embodiment” or “an embodiment” in various places throughout this specification are not necessarily all referring to the same embodiment. Furthermore, particular features, structures, or characteristics may be combined in one or more embodiments.

In an embodiment, an avalanche photodiode detector (APD) may be used to receive an optical signal in an optical communications system, for example. An APD may have an improved sensitivity over a PiN photodiode for photon detection. The APD may be biased with an electric field across its junction to produce an increased electron flow for a given flux of photons. Gain of such an APD may depend, at least in part, on the electric field applied. Normally, the higher a reverse voltage, the higher the gain will be. However, if the reverse voltage is increased further, beyond a breakdown threshold, for example, a voltage drop may occur due to a current flowing through the device, wherein this current may detrimentally no longer be proportional to the amount of incident light.

It may be desirable to bias the APD at relatively large reverse potentials that are just below a threshold breakdown voltage of the APD. However, needless to say, biasing the APD close to the breakdown voltage may present a precarious situation. Slipping into the breakdown regime may, for example, render the APD useless as a photo detector and may also result in its destruction, potentially along with other components resulting from an over-current condition.

While attempting to keep a reverse bias, or drive, voltage relatively steady, several factors may modify the drive voltage enough to result in APD breakdown by increasing the drive voltage so that it reaches or exceeds the threshold voltage. For example, APD temperature may affect some of its operational parameters, such as the APD breakdown voltage, for example, which may rise or fall with changing temperature. Also, random voltage fluctuations, such as noise present along with the bias voltage, may be enough to push the total bias voltage over the breakdown threshold. For example, a 35 volt drive voltage may be used to drive an APD with a 36 volt breakdown voltage (at a specific temperature, for instance). In this case, a noise spike of one volt or more may therefore be enough to drive the APD into a breakdown condition. Alternatively, the APD temperature may drift enough to lower the breakdown voltage to within a noise margin of the drive voltage centered at 35 volts, such as a 0.5 volt ripple. Thus, one can see that APD temperature and bias voltage noise may create, separately or together, an unstable APD operating condition. Accordingly, it may be desirable for a voltage supply that supplies the drive voltage to be kept relatively stable with relatively low noise in order to operate an APD.

Assuming that APD temperature is carefully adjusted to be substantially constant with relatively low noise, its influence on the task of keeping the APD driven close to, but safely away from, the breakdown voltage may be reduced. Noise may also be kept within reasonable bounds so as not to significantly adversely affect the APD driving voltage. But suppressing or reducing noise may not easily be done in the confines of a physically small circuit package, since it generally takes physically large-sized capacitors to suppress or reduce noise.

As mentioned above, an APD may be used to receive an optical signal in an optical communications system. In particular, an APD may be included in a small form factor pluggable (SFP) module, such as one used in telecom or datacom applications, to change an optical signal into an electrical signal or vice versa. Multi-source agreement (MSA) specifications currently dictate physical size of an SFP module. For example, an SFP size of approximately 57×14×9 mm may not accommodate a capacitor large enough to reduce or suppress APD bias noise as much as desired to operate an APD close to an APD breakdown voltage. Unfortunately, placing a large noise-reducing capacitor beyond the confines of the SFP module may not provide sufficient noise reduction. Furthermore, it would be less compact. As an alternative, one may reduce the drive voltage to increase margin between the APD operating point and the breakdown voltage. However, this may degrade overall performance due to a reduction of drive voltage.

However, as discussed in more detail below, in one particular embodiment, an APD may be operated close to its breakdown voltage without the use of a physically large-sized capacitance. Accordingly, an APD may be driven within precise control limits while not slipping into a breakdown condition. Staying within such limits, for example, results in at least satisfactory circuit performance. Such precise limits, in one embodiment, may be related to limiting noise of the drive voltage to less than, say, 0.3%, just to give an example. As another example, an APD voltage may be 36.94V, including 40 mV of signal noise. This noise may be reduced to, say, 4 mV by utilizing feedback, as will be described below. It is, of course, appreciated that the foregoing are merely examples and claimed subject matter is not limited in scope to these examples.

Benefits of suppressing or reducing signal noise, such as increased signal stability near an APD breakdown voltage, described above, may also include improved APD sensitivity. An APD input signal is typically weak, so less noise may improve sensitivity.

In a particular embodiment, benefits of incorporating feedback, as mentioned above, may also include protecting an APD from too high input power. For example, a resistor in series with an APD may be larger in a circuit that includes feedback compared to one without feedback. Such a resistor may reduce APD damage due to relatively high input power. In a specific example, no damage may occur for +5 dBm input power with a feedback circuit. The same APD, however, may be damaged for input power as low as −3 dBm without feedback.

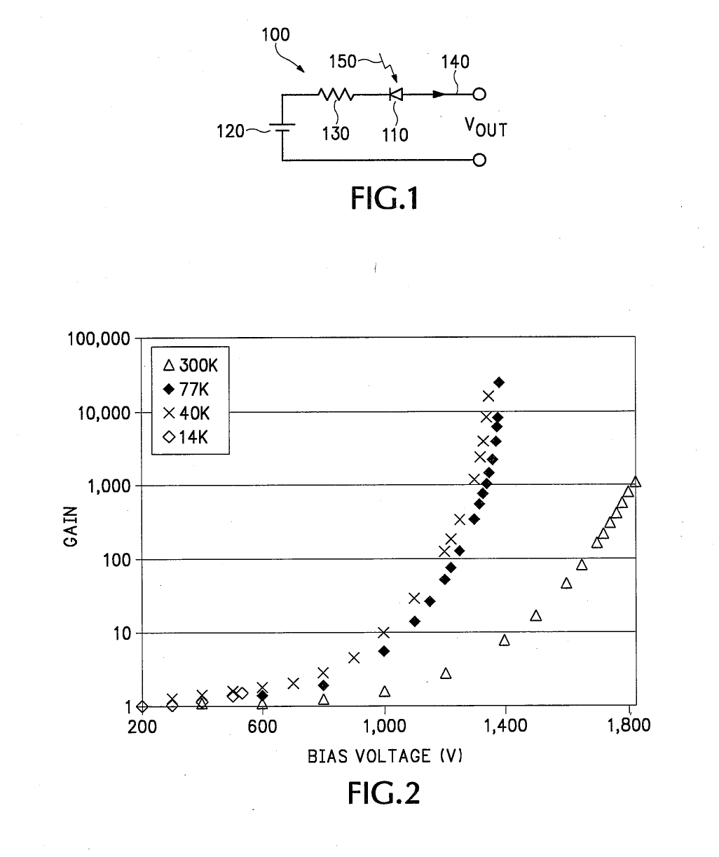

FIG. 1 is a circuit diagram of an embodiment 100 of a photosensor circuit that may be used for measuring light. Here, light is defined to include electromagnetic radiation of any wavelength, including wavelengths in UV, visible, or infrared spectra. An external light source may include a laser diode or an LED, just to list a few examples. Of course, claimed subject matter is not limited in scope to any particular embodiment. Nonetheless, here, photosensor circuit embodiment 110 may be reverse biased by an applied drive voltage 120. Likewise, photosensor 110 may comprise a PiN photodiode or an avalanche photodiode (APD), just to name a few examples. A resistor 130 may be serially coupled or connected between photosensor 110 and the applied drive voltage to limit a drive current. Light 150 impinging on photosensor 110, for example, may generate a photocurrent 140 that may be measured at an output port, Vout. Though photosensors can generate a photocurrent due to the photovoltaic effect without the need for an external power source, aspects of photosensor circuit embodiment 100 may be improved by including applied drive voltage 120. For example, photosensor circuit 100 may have improved light sensitivity compared with an equivalent circuit having no drive voltage 120.

Furthermore, the photosensitivity of photosensor circuit 100 may continue to be improved as applied drive voltage 120 increases, until reaching a photosensor threshold voltage close to, but before, breakdown, as described above. Commonly known as Avalanche Breakdown, this undesirable photosensor condition may result in an operational failure of and possible damage to the circuit. Thus, a challenge may be to operate a photosensor circuit 100 relatively close to the photosensor breakdown without crossing this threshold. For example, complications may arise if photosensor parameters, such as breakdown voltage, are at least in part temperature dependent, as suggested previously. Thus, all else being held constant, a changing temperature may push a photosensor into avalanche breakdown, as mentioned above. Also possibly complicating matters, as previously discussed, noise may affect the photosensor circuit performance, if it results in a voltage exceeding the breakdown voltage. For example, if the applied drive voltage noise includes voltage spikes, then the photosensor may slip into breakdown condition if a noise spike jumps high enough to push the total drive voltage beyond the breakdown voltage.

For a particular APD, FIG. 2 shows a relationship between APD gain and an applied drive voltage for several different temperatures. In particular, the X-axis indicates the applied drive voltage applied across the APD and the Y-axis indicates the APD gain. From FIG. 2, one can see that gain may improve as the applied drive voltage is increased, so that it may be desirable to operate an APD at a relatively high drive voltage for improved gain, as described above. Breakdown voltage is not shown in FIG. 2 because such plotted points would be beyond the edge of the plot.

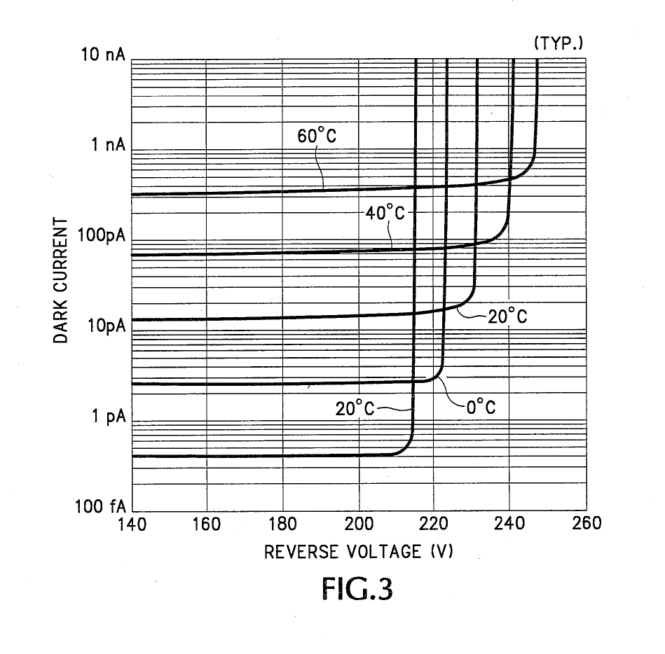

For a particular APD, FIG. 3 shows a relationship between APD dark current and an applied drive voltage. In particular, the X-axis indicates the applied drive voltage applied across the APD and the Y-axis indicates dark current that represents noise level of the APD. The sharp transition of each of the plots at the various temperatures represents APD breakdown. Thus, according to FIG. 3, APD breakdown voltage may increase with temperature, at least for this particular APD.

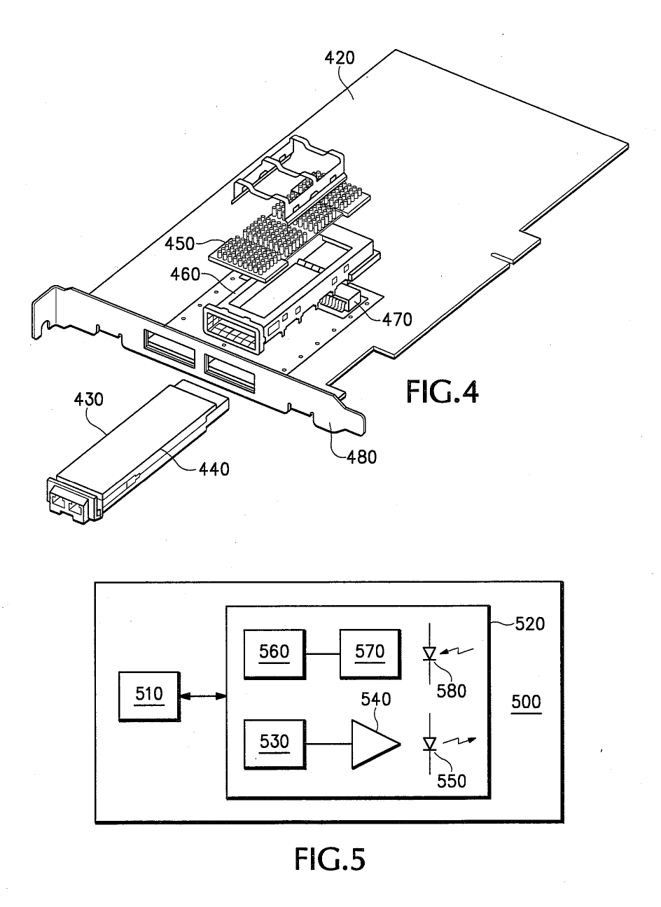

FIG. 4 is a perspective diagram of an SFP/XFP transceiver module embodiment 440 incorporating a photosensor controller circuit 430, according to an embodiment. Both a host board 420 and transceiver module 440 may meet electrical, management, and mechanical specifications for SFP/XFP modules set by a multi-source agreement (MSA). In particular, host board 420 may comprise a printed circuit board to which a cage assembly 460 and connector 470 for receiving transceiver module 440 is mounted. A heat sink 450 may be thermally coupled to cage assembly 460. A bezel 480 may be coupled to a front edge of host board 420 for securing host board 420 to a rack (not shown), for example. In this context, for example, “coupled” may mean directly or indirectly connected. Module embodiment 440 may comprise a small form-factor pluggable (SFP) module, or an XFP module.

Module 440, by conforming with SFP or XFP industry specifications, may be subject to small size limitations.

Module 440 may include various transceiver components, as shown in FIG. 5. For example, FIG. 5 is a schematic diagram showing a configuration of an XFP module incorporating receiver electronics and connected to a host board 500 that includes an electronics portion 510, according to an embodiment. In this embodiment, an XFP module 520 may be mountable on the host board 500 and connectable to electronics portion 510, which may include any number of application-specific circuits and components, switches, and routers, just to name a few examples.

XFP module 520 may include a transmitter 530 having a voltage driver 540 to drive a light source 550. Light source 550 may include a light emitting diode (LED) or a laser diode (LD), just to name a few examples. XFP module 520 may also include a receiver 560 coupled to receiver electronics 570 and a detector module 580. Detector module 580 may include a PiN photodiode or an APD, just to name a few examples. Receiver electronics 570 may include a driver circuit to reverse bias detector module 580, and may also include temperature compensation electronics (not shown), for example.

Features of a driver circuit, such as one that may be included in receiver electronics 570, desirably may include a small circuit footprint and low output noise. Despite the sensitivity of a photosensor to input driver noise if driven close to its breakdown threshold, as discussed above, boost-switching regulators, possibly noisy by their nature of operating, may be commonly used in modules, such as XFP or SFP modules, for example, at least in part because of their relatively high efficiency and small size. To counteract this noise, a noise-reducing capacitance may be included in the drive circuit, desirably relatively close to the drive circuit.

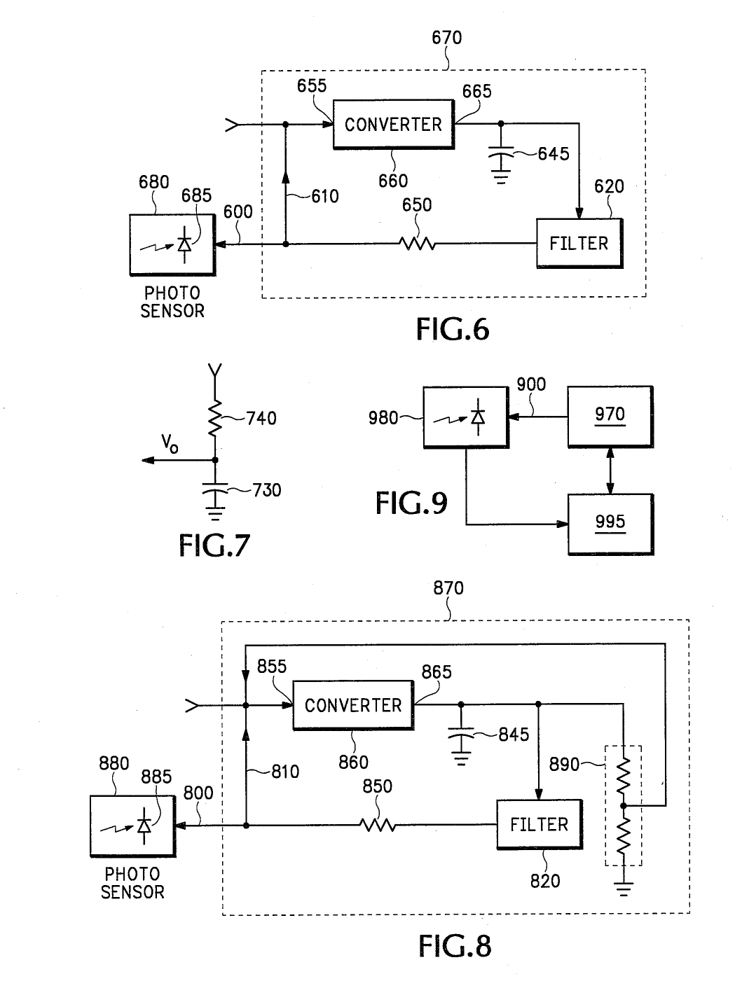

FIG. 6 is a circuit diagram showing a configuration of a photosensor controller 670 incorporating a filter 620 and a feedback portion 610, according to an embodiment. Photosensor controller 670 may generate a drive voltage at a control port 600 of a detector module 680 that includes a photosensor 685. Photosensor 685 may include a PiN photodiode or an APD, just to name a few examples. The drive voltage may be applied to photosensor 685 as a reverse bias voltage. Photosensor controller 670 may include a converter 660, such as a DC-DC converter, for example. Such a DC-DC converter may include a boost-switching regulator, for example, which may tend to produce ripple noise along with its output signal. Output capacitance 645 tied to ground may be placed at an output port 665 of converter 660 to assist in suppressing or reducing such converter noise. In this embodiment, output capacitance 645 comprises a circuit component, such as a capacitor.

Feedback portion 610 may be applied to an input port 655 of converter 660. A filter 620 may be coupled or connected to output port 665. Filter 620 may include an RC filter, such as the embodiment shown in FIG. 7, having a resistor 740 and a capacitor 730 that may be tied to ground, for example. The voltage across capacitor 730 may be applied to feedback portion 610. A resistor 650 or other circuit components may be included in feedback portion 610 to modify current or voltage along feedback portion 610. For example, the voltage at output port 665 of converter 660 may be scaled by a factor, such as associated with resistor 650 or other components, before it is applied to feedback portion 610.

As mentioned above, output capacitance 645 may be located, for example, at output port 665 to assist in reducing noise that may be produced by converter 660. If photosensor controller 670 is included in a space-limiting SFP/XFP module, for example, a size limitation in terms of dimensions may be placed on output capacitance 645. Size constraints on a capacitor may limit its ability to assist in reducing noise. However, in accordance with embodiment of FIG. 6, filter 620 and feedback portion 610 may provide additional advantages. The presence of filter 620 and feedback portion 610 may enable output capacitance 645 to be smaller than what may normally be desired to yield a sufficient amount of noise reduction, while the capacitance of filter 620 is also able to be small. Accordingly, improved noise reduction may be achieved without employing relatively large-sized capacitors, for example. (as opposed to large valued capacitors)

Consider an example in which photosensor 685 comprises an APD. To drive the APD within, say, 2% of its breakdown voltage for a relatively high gain, an output capacitance 645 of about 1 microfarad may be employed to reduce drive voltage noise enough to enable the APD to be driven within 2% of the previous goal. Such a capacitance may comprise a capacitor that is physically too large to fit in a module, such as an SFP module, for example. But with the inclusion of feedback portion 610 and filter 620, output capacitance 645 may be reduced to 0.47 microfarad, for example. Accordingly, a smaller output capacitance 645 and filter 620 may fit into a module, such as an SFP module, for example.

FIG. 8 is a circuit diagram showing a configuration of a photosensor controller embodiment 870 incorporating a filter 820 and a feedback portion 810, according to another embodiment. Similar to the embodiment of FIG. 6, photosensor controller 870 may generate a drive voltage at a control port 800 of a detector module 880 that includes a photosensor 885. Photosensor 885 may include a PiN photodiode or an APD, just to name a few examples. Again, the driver voltage may be applied to photosensor 885 as a reverse bias voltage. Photosensor controller 870 may include a converter 860, such as a DC-DC converter, for example. An output capacitance 845, which comprises a capacitor, tied to ground may be placed at an output port 865 of converter 860.

Feedback portion 810 may be applied to an input port 855 of converter 860. A filter 820 may be coupled to output port 865. Filter 820 may include an RC filter, for example. A resistor 850 or other circuit components may be included in feedback portion 810 to modify current or voltage along feedback portion 810. For example, voltage at output port 865 of converter 860 may be scaled by a factor before it is applied to feedback portion 810. Likewise, voltage divider 890 may be connected to output port 865 in parallel with output capacitance 845. A reduced voltage scaled by voltage divider 890 may be applied to input port 855 of converter 860 as feedback, along with feedback portion 810.

As in the embodiment of FIG. 6, photosensor controller 870 may also include a filter 820 and feedback portion 810 that may allow a relatively high level of noise reduction. Likewise, photosensor 880, converter 860, feedback portion 810, output capacitor 845, and filter 820 may be incorporated in a single module with other components. Such a module may include an SFP or XFP module, which may have a size of approximately 57×14×9 mm. The module may be a hot pluggable, small footprint, serial-to-serial, data-agnostic, multirate optical transceiver, for example; although, of course, claimed subject matter is not limited in scope in this respect.

Since temperature of an APD may affect its gain or other parameters, APD drive voltage may be varied to at least partially address for APD temperature changes. FIG. 9 is a circuit diagram showing, according to an embodiment, a configuration of a photosensor controller 970 incorporating a filter and feedback portion, as described above. Photosensor controller 970 may supply a drive voltage at a control port 900 of a photosensor 980. The photosensor may include an onboard temperature sensor (not shown), such as a thermistor or thermocouple, for example. A temperature controller 995 may be coupled to photosensor 980 to sense photosensor temperature. The temperature controller may be connected to photosensor controller 970 to vary the drive voltage to compensate for changes in gain or other photosensor parameters due at least in part to temperature changes.

One skilled in the art will realize that an unlimited number of variations to the above descriptions is possible, and that the examples and the accompanying figures are merely to illustrate one or more particular implementations.

While there has been illustrated or described what are presently considered to be example embodiments, it will be understood by those skilled in the art that various other modifications may be made, or equivalents may be substituted, without departing from claimed subject matter. Additionally, many modifications may be made to adapt a particular situation to the teachings of claimed subject matter without departing from concepts or claimed subject matter described herein. Therefore, it is intended that claimed subject matter not be limited to the particular embodiments disclosed, but that such claimed subject matter also include all embodiments falling within the scope of the appended claims, or equivalents thereof.

1. A method of controlling a voltage driving a semiconductor photosensor within precise limits so as not to result in breakdown of the photosensor, said method comprising:
applying the drive voltage to the photosensor, the drive voltage being produced as an output voltage of a voltage converter as follows:
converting an input voltage to an output voltage via said voltage converter;
filtering said output voltage of said voltage converter via circuitry that includes a capacitance, wherein said capacitance is much less than a capacitance sufficient to maintain the photosensor voltage with said precise limits; and
applying the filtered output voltage at least as a portion of the input voltage of said voltage converter.

2. The method of claim 1, wherein filtering said output voltage is performed with said capacitance being less than 1 microfarad.

3. The method of claim 1, further comprising varying the drive voltage based at least in part on temperature changes of the photosensor.

4. The method of claim 1, further comprising driving the photosensor near the breakdown of the photosensor.

5. The method of claim 1, wherein the photosensor comprises a PIN photodiode.

6. The method of claim 1, wherein the photosensor comprises an avalanche photodiode (APD).

7. The method of claim 1, wherein the voltage converter comprises a DC-DC converter.

8. An apparatus comprising:
a semiconductor photosensor including at least a control port;
a voltage converter having an output capacitor and an output port, said voltage converter to drive an output voltage within precise limits so as not to result in a breakdown of the photosensor, wherein the output capacitor by itself is not sufficient to maintain the output voltage within the precise limits; and
voltage converter feedback circuitry to receive a portion of said output voltage.

9. The apparatus of claim 8 further comprising:
an RC filter coupled to said voltage converter feedback circuitry, wherein the capacitance of said RC filter is much less than a capacitance of the output capacitor.

10. The apparatus of claim 9, wherein the photosensor, voltage converter, feedback circuitry, output capacitor, and RC filter are incorporated in a single module.

11. The apparatus of claim 10, wherein said single module comprises a transceiver.

12. The apparatus of claim 8, wherein said voltage converter is incorporated in a low-profile 2 mm×2 mm integrated circuit module.

13. The apparatus of claim 8, wherein said output capacitor has a value less than 1 micro farad.

14. The apparatus of claim 8, wherein said precise limits include a limitation on a ripple voltage less than or equal to 0.3% of the control voltage.

15. The apparatus of claim 8, wherein said voltage converter to vary the output voltage at least partly based on temperature changes of the photosensor.

16. The apparatus of claim 8, wherein the photosensor comprises a PIN photodiode.

17. The apparatus of claim 8, wherein the photosensor comprises an avalanche photodiode (APD).

18. The apparatus of claim 11, wherein said transceiver comprises an SFP or an XFP module.

19. The apparatus of claim 18, wherein said SFP or XFP module comprises a hot pluggable, small footprint, serial-to-serial, data-agnostic, multirate optical transceiver.

20. The apparatus of claim 8, wherein the voltage converter comprises a DC-DC converter.

21. A device comprising:
a circuit to drive an avalanche photodiode (APD) at a voltage less than a breakdown voltage and within precise limits by controlling a bias voltage to be applied to said APD, wherein said circuit includes:
a DC-DC converter including an input port and an output port to produce an output voltage;
a feedback loop to couple the input port to the output port and to scale said output voltage by a factor; and
a low-pass RC filter coupled to said output port, wherein the capacitance of the RC filter is much less than a capacitance sufficient to maintain said bias voltage with said precise limits.

22. The device of claim 21, wherein said circuit, APD, DC-DC converter, and the RC filter are incorporated in a single module.

23. The device of claim 22, wherein said single module comprises a transceiver.

24. The device of claim 21, wherein said DC-DC converter is incorporated in a low-profile 2 mm×2 mm integrated circuit module.

25. The device of claim 21, wherein the RC filter comprises a capacitor having a value less than 1 microfarad.
